(19) United States
(12) Patent Application Publication
(10) Pub. No.: US 2011/0134142 A1
(43) Pub. Date: Jun. 9, 2011

(54) DISPLAY DEVICE AND DRIVING METHOD THEREOF

(75) Inventors: Shunpei Yamazaki, Tokyo (JP); Hajime Kimura, Atsugi (JP)

(73) Assignee: SEMICONDUCTOR ENERGY LABORATORY CO., LTD., Atsugi-shi (JP)

(21) Appl. No.: 12/956,540

(22) Filed: Nov. 30, 2010

(30) Foreign Application Priority Data
Dec. 4, 2009 (JP) 2009-276269

(51) Int. Cl. G09G 3/36; G09G 5/00

(52) U.S. Cl. 345/634; 345/87

(57) ABSTRACT

An object is to reduce residual images and power consumption in a liquid crystal display device. The liquid crystal display device capable of inputting an image signal to a pixel portion selectively is provided. It is possible for the liquid crystal display device to input the image signal only to a region in which a fast-moving image is displayed. Therefore, residual images in displaying a moving image can be reduced. Further, in the liquid crystal display device, it is acceptable that the image signal is not input to a region in which a slow-moving image is displayed; accordingly, power consumption can be reduced.

### BACKGROUND OF THE INVENTION

1. Field of the Invention

The present invention relates to liquid crystal display devices. In particular, the present invention relates to liquid crystal display devices capable of frame rate driving. In addition, the present invention relates to a driving method of the liquid crystal display devices.

2. Description of the Related Art

Display devices such as liquid crystal display devices form images (still images) based on image signals input from the outside and sequentially display the images, thereby displaying moving images.

Note that the moving image is formed of many still images. That is, strictly speaking, the moving image is not a continuous image. Accordingly, when fast moving images are displayed, residual images are likely to be generated in display. Particularly in liquid crystal display devices, each pixel maintains display from when an image signal is input to the pixel to when the next image signal is input to the pixel; therefore, residual images tend to be apparent.

In Patent Document 1, a technique to reduce the above-described residual images (referred to as “double-frame rate driving” in general) is disclosed. Specifically, in Patent Document 1, the following technique is disclosed: an image for interpolation is formed between two images displayed sequentially, and the image is inserted between two images displayed sequentially, so that residual images are reduced.

### REFERENCE

[Patent Document 1] Japanese Published Patent Application No. H04-302289

### SUMMARY OF THE INVENTION

In many liquid crystal display devices, a capacitor is provided for each pixel so that voltage applied to liquid crystal elements can be held and inversion driving is performed to suppress deterioration of the liquid crystal elements. That is, power consumption is largely changed in accordance with the number of image signals input to each pixel. Meanwhile, it can be said that the above technique is a technique for increasing the number of image signals input to each pixel included in a liquid crystal display device per unit time. Therefore, in the liquid crystal display device for which the technique is used, an increase in power consumption is inevitable.

In a view of the above problems, it is an object of one embodiment of the present invention to provide liquid crystal display devices in which reduction both in residual images and in power consumption can be realized.

The above problems can be solved by inputting an image signal for forming an interpolation image to a pixel portion selectively.

That is, one embodiment of the present invention is a liquid crystal display device in which a pixel portion is divided into a plurality of regions and whether an image signal is input or not is selected depending on a region of the plurality of regions.

As a specific example of the above liquid crystal display device, a liquid crystal display device described below can be given.

That is, one embodiment of the present invention is a liquid crystal display device including a processor which compares a first image and a second image formed in accordance with image signals input from the outside and generates an image signal for forming a third image for being interpolated between the first image and the second image; a gate driver and a source driver whose operation is controlled by an output signal of the processor; and a pixel portion where display is performed by output signals of the gate driver and the source driver. The pixel portion is divided into a plurality of regions and whether the image signal for forming the third image is input is selected depending on a region of the plurality of regions.

Further, in a liquid crystal display device according to one embodiment of the present invention, the number of interpolation images is not limited to one.

That is, one embodiment of the present invention also includes a liquid crystal display device including a processor which compares a first image and a second image formed in accordance with image signals input from the outside and generates an image signal for forming a third image to an n-th image (n is a natural number of 4 or more) for being interpolated between the first image and the second image; a gate driver and a source driver whose operation is controlled by an output signal of the processor; and a pixel portion where display is performed by output signals of the gate driver and the source driver. The pixel portion is divided into a plurality of regions and whether the image signals for forming the third image to the n-th image are input is selected depending on a region of the plurality of regions.

Furthermore, a liquid crystal display device according to one embodiment of the present invention can selectively input an image signal input from the outside to a pixel portion.

That is, one embodiment of the present invention also includes a liquid crystal display device including a processor which compares a first image to an n-th image (n is a natural number of 2 or more) formed in accordance with image signals input from the outside; a gate driver and a source driver whose operation is controlled by an output signal of the processor; and a pixel portion where display is performed by output signals of the gate driver and the source driver. The pixel portion is divided into a plurality of regions and whether the image signals for forming the first image to the n-th image are input is selected depending on a region of the plurality of regions.

Further, a liquid crystal display device according to one embodiment of the present invention can selectively input an image signal for forming an interpolation image to a pixel portion and selectively input an image signal input from the outside to a pixel portion, concurrently.

That is, one embodiment of the present invention also includes a liquid crystal display device including a processor which compares a first image to an n-th image (n is a natural number of 2 or more) formed in accordance with image signals input from the outside, compares a k-th image (k is a natural number of 1 or more and less than n) and a (k+1)-th image, and generates image signals for forming an (n+1)-th image to an m-th image (m is a natural number of (n+2) or more) for being interpolated between the k-th image and the (k+1)-th image; a gate driver and a source driver whose operation is controlled by an output signal of the processor; and a pixel portion where display is performed by output signals of the gate driver and the source driver. The pixel portion is divided into a plurality of regions and whether the image signals for forming the first image to the m-th image are input is selected in accordance with a region of the plurality of regions.

According to one embodiment of the present invention, an image signal can selectively be input to a pixel portion. That is, the one embodiment of the present invention can input the image signal only to a region in which a fast-moving image is displayed. Therefore, residual images in displaying a moving image can be reduced. Further, it is possible that the image signal is not input to a region in which a slow-moving image is displayed. Accordingly, power consumption can be reduced.

### BRIEF DESCRIPTION OF THE DRAWINGS

FIGS. 1A and 1B illustrate a liquid crystal display device according to Embodiment 1.

FIGS. 2A and 2B illustrate a liquid crystal display device according to Embodiment 1.

FIGS. 3A and 3B illustrate a liquid crystal display device according to Embodiment 1.

FIG. 4 illustrates a liquid crystal display device according to Embodiment 1.

FIGS. 5A to 5D illustrate a liquid crystal display device according to Embodiment 1.

FIG. 6 illustrates a liquid crystal display device according to Embodiment 1.

FIGS. 7A and 7B illustrate a liquid crystal display device according to Embodiment 2.

FIG. 8 is a longitudinal sectional view of an inverted-staggered thin film transistor including an oxide semiconductor.

FIGS. 9A and 9B are energy band diagrams (schematic diagrams) corresponding to a cross section taken along line A-A′ in FIG. 8.

FIG. 10A is a diagram illustrating a state where a positive potential (+VG) is applied to a gate electrode layer (GE1), and FIG. 10B is a diagram illustrating a state where a negative potential (−VG) is applied to the gate electrode layer (GE1).

FIG. 11 illustrates a relation between the vacuum level and the work function of a metal (φM) and a relation between the vacuum level and the electron affinity of an oxide semiconductor (χ).

FIGS. 12A to 12D illustrate manufacturing steps of a thin film transistor.

FIGS. 13A to 13D each illustrate a liquid crystal display device according to Embodiment 2.

FIGS. 14A to 14C each illustrate a liquid crystal display device according to Embodiment 3.

FIGS. 15A and 15B each illustrate a liquid crystal display device according to Embodiment 3.

FIGS. 16A to 16C illustrate a liquid crystal display device according to Embodiment 3.

FIG. 17 illustrates a liquid crystal display device according to Embodiment 3.

FIGS. 18A to 18F each illustrate an electronic device according to Embodiment 4.

### DETAILED DESCRIPTION OF THE INVENTION

Hereinafter, embodiments of the present invention will be described in detail with reference to the accompanying drawings. Note that the present invention is not limited to the description below, and it is easily understood by those skilled in the art that a variety of changes and modifications can be made without departing from the spirit and scope of the present invention. Therefore, the present invention should not be limited to the descriptions of the embodiments below.

Note that since a source terminal and a drain terminal of a transistor change depending on the structure, the operating condition, or the like of the transistor, it is difficult to define which is a source terminal or a drain terminal. Therefore, one of a source terminal and a drain terminal is referred to as a first terminal and the other is referred to as a second terminal for distinction in this specification.

Note that the size, the thickness of a layer, or a region of each structure illustrated in drawings or the like in embodiments is exaggerated for simplicity in some cases. Therefore, the actual scale is not limited to such a scale. Further, in this specification, ordinal numbers such as “first”, “second”, and “third” are used in order to avoid confusion among components, and the terms do not limit the components numerically.

### Embodiment 1

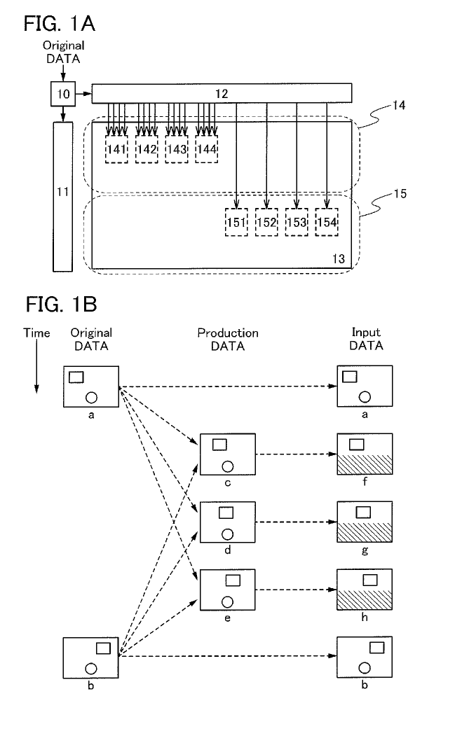

In Embodiment 1, an example of an active matrix liquid crystal display device is described. Specifically, an active matrix liquid crystal display device which can select whether double-frame rate driving is performed on a region of a plurality of regions included in a pixel portion is described with reference to FIGS. 1A and 1B, FIGS. 2A and 2B, FIGS. 3A and 3B, FIG. 4, FIGS. 5A to 5D, and FIG. 6.

A liquid crystal display device in Embodiment 1 can store image data which is formed on the basis of an image signal input from the outside for a certain period. In addition, the liquid crystal display device of Embodiment 1 can store data of a plurality of images and can detect a motion vector by comparison between two images displayed sequentially. At this time, an interpolation image of two images displayed sequentially is formed on the basis of the motion vector. Note that the number of the interpolation image is not limited to one. It is possible to change the number of the images depending on the magnitude of the motion vector. Further, an image signal for displaying the interpolation image can be selectively input to each region of a pixel portion depending on the magnitude of the motion vector.

A structure example and an operation example of the liquid crystal display device of Embodiment 1 will be described below with reference to FIGS. 1A and 1B. A liquid crystal display device in FIG. 1A includes a processor 10 to which an image signal is input from the outside, a pixel portion 13 which includes a plurality of pixels arranged in matrix, and a gate driver 11 and a source driver 12 operation of which is controlled by an output signal from the processor 10. Note that the gate driver 11 controls the plurality of pixels so that an image signal can be input thereto every row. The source driver 12 outputs an image signal to the plurality of pixels.

### <Original DATA>

Here, an image signal for forming an image a (an image in which a square and a circle are depicted in an upper-left region and a lower-center region, respectively) in FIG. 1B, and an image signal for forming an image b (an image in which a square and a circle are depicted in an upper-right region and a lower-center region, respectively) are input from the outside to the processor 10. Note that the positions of the circles in the images a and b are the same.

### <Production DATA>

The processor 10 detects a motion vector by comparison between the images a and b. Image signals for forming an image c, an image d, and an image e are generated. The images c to e are interpolation images of the images a and b. That is, a square in the image c is moved from the position of the square in the image a toward that in the image b by one fourth of the distance between the positions, the square in the image d is moved to the middle between the position of the square in the image a and that in the image b, and the square in the image e is moved from the position of the square in the image a toward that in the image b by three fourth of the distance between the positions. Note that the positions of circles in the images a to e are the same.

### <Input DATA>

The image a, the images c to e, and the image b are sequentially displayed in the pixel portion 13 after the image signals for forming the images c to e are generated. Specifically, image signals for displaying the image a, the images c to e, and the image b are input from the source driver 12 to a plurality of pixels included in the pixel portion 13. Note that the image signals for displaying the images c to e are input to a pixel group (pixels 141, 142, 143, 144, and the like) included in a region 14 but not to a pixel group (pixels 151, 152, 153, 154, and the like) included in a region 15 (see FIG. 1A). That is, as illustrated in FIG. 1B, an image f, an image g, and an image h are interpolated between the images a and b. Note that the image f corresponds to the upper region of the image c, the image g corresponds to the upper region of the image d, and the image h corresponds to the upper region of the image e. Further, when image signals of the images f to h are input, an image signal is not input to the lower region of the pixel portion 13 and an image in the lower region of the image a is held. Furthermore, in the liquid crystal display device of Embodiment 1, the processor 10 determines a pixel group in a region of the pixel portion 13, to which an image signal for forming an interpolation image is input. Specifically, the region is determined by the magnitude of the motion vector which is detected by comparison between the images a and b.

The liquid crystal display device of Embodiment 1 generates an image signal (Production DATA) for forming an interpolation image based on an image signal (Original DATA) input from the outside. Further, the image signal (Production DATA) for forming an interpolation image is input to a pixel group included in a certain region, not to all of the pixels included in the pixel portion. The region is the region in which the motion vector detected by the image signal (Original DATA) input from the outside is large; that is, the region in which a residual image becomes apparent. In other words, the image signal (Production DATA) for forming an interpolation image is not input to a pixel group included in a region in which a residual image is not apparent. Therefore, residual images can be reduced in displaying moving images and the increase in power consumption can be suppressed.

### Specific Example

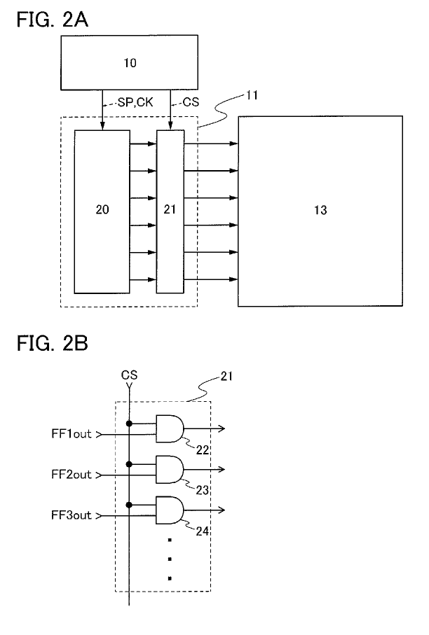

A specific example of the above liquid crystal display device will be described below with reference to FIGS. 2A and 2B. FIG. 2A illustrates a structure of the gate driver 11 in more detail. The gate driver 11 illustrated in FIG. 2A includes a shift register 20 to which a signal is input from the processor 10, and an output control circuit 21 to which a signal is input from the processor 10 and the shift register 20. Note that the processor 10 outputs a start pulse signal (SP), a clock signal (CK), and the like to the shift register 20, and outputs an output control signal (CS) or the like to the output control circuit 21.

The shift register 20 outputs a signal which controls switching of switches included in a plurality of pixels arranged in matrix and included in the pixel portion 13. Specifically, the shift register 20 includes a plurality of flip-flops connected in series (not shown). In the shift register 20, an output signal of a flip-flop is sequentially shifted to the next flip-flop and output to the output control circuit 21.

The output control circuit 21 selects whether the inputted signal from the shift register 20 is output to the pixel portion 13 or not. Specifically, as illustrated in FIG. 2B, the output control circuit 21 includes a plurality of AND gates 22, 23, and 24. A first input terminal of each AND gate is electrically connected to a wiring (hereinafter, also referred to as a control signal line) supplying the control signal (CS) output from the processor 10. A second input terminal of the AND gate is electrically connected to a wiring supplying an output signal of one of the flip-flops included in the shift register 20. That is, a first input terminal of the AND gate 22 is electrically connected to the control signal line and a second input terminal of the AND gate 22 is electrically connected to a wiring supplying an output signal (FF1out) of a flip-flop of the first stage included in the shift register 20. Similarly, first input terminals of the AND gate 23 and the AND gate 24 are electrically connected to the control signal line and second terminal of the AND gate 23 and second terminal of the AND gate 24 are electrically connected to a wiring supplying an output signal (FF2out) of a flip-flop of the second stage included in the shift register 20 and a wiring supplying an output signal (FF3out) of a flip-flop of the third stage included in the shift register 20, respectively. Further, an output signal of the AND gate 22 is input to the plurality of pixels which are arranged in the first row among a plurality of pixels arranged in matrix and included in the pixel portion 13. Similarly, an output signal of the AND gate 23 is input to a plurality of pixels arranged in the second row, and an output signal of the AND gate 24 is input to a plurality of pixels arranged in the third row.

In a liquid crystal display device including the gate driver 11 with the above structure, the control signal (CS) output from the processor 10 makes it possible to select whether an image signal is input or not to a plurality of pixels which are arranged in matrix and included in the pixel portion 13 depending on a row. Specifically, the following is acceptable: the control signal (CS) is synchronized with an output signal of a flip-flop when an image signal is input to a plurality of pixels arranged in a specific row, and the control signal (CS) is not synchronized with an output signal of a flip-flop when an image signal is not input thereto. Note that it is not necessary that the control signal (CS) is completely synchronized with an output signal of a flip-flop even in the case where an image signal is input to a plurality of pixels arranged in a specific row. For example, the pulse width of the control signal (CS) can be smaller than that of an output signal of the flip-flop, which reduces malfunctions such as the case where an image signal is input to a pixel except for a pixel to which the image signal is to be input. In addition, it is also acceptable that the above liquid crystal display device has a structure in which an output signal of the output control circuit 21 is input to the pixel portion 13 through a buffer circuit and/or the like.

Further, in the above liquid crystal display device, local dimming is preferably performed in accordance with an image signal for forming an interpolation image. Note that local dimming means the process for controlling a backlight included in the liquid crystal display device locally. Local dimming enables improvement in the contrast of a moving image displayed by the liquid crystal display device.

Moreover, in the above liquid crystal display device, backlight scanning is preferably performed. Note that backlight scanning means the process for turning off the backlight for a split second in switching images displayed by the liquid crystal display device. Backlight scanning enables further reduction of residual images in displaying a moving image of the liquid crystal display device. Note that backlight scanning can be performed on the entire pixel portion or part of the pixel portion. For example, as illustrated in FIG. 1B, when an image signal for interpolation is input only to the upper region (the region 14) of the pixel portion 13, backlight scanning or the like can be performed only on the upper region before the image signal is input.

Further, the above liquid crystal display device can have a structure in which the source driver 12 is deactivated by stopping supply of a signal from the processor 10 to the source driver 12 or a structure in which whether an image signal is input from the source driver 12 to the pixel portion 13 or not is selected.

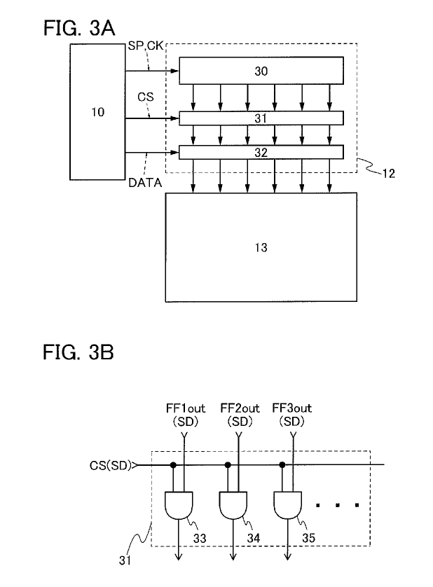

A specific example of the latter structure will be described with reference to FIGS. 3A and 3B. FIG. 3A illustrates a structure of the source driver 12 in more detail. The source driver 12 illustrated in FIG. 3 includes a shift register 30 to which a signal is input from the processor 10, an output control circuit 31 to which a signal is input from the processor 10 and the shift register 30, and a sampling circuit 32 to which an image signal from the processor 10 and a signal from the output control circuit 31 are input. Note that the processor 10 outputs the start pulse signal (SP), the clock signal (CK), and the like to the shift register 30, outputs the output control signal (CS) or the like to the output control circuit 31, and outputs an image signal (DATA) or the like to the sampling circuit 32.

The shift register 30 outputs a signal for controlling the sampling circuit 32. Specifically, the shift register 30 includes a plurality of flip-flops connected in series (not shown). In the shift register 30, an output signal of a flip-flop is sequentially shifted to the next flip-flop and output to the output control circuit 31.

The output control circuit 31 selects whether the inputted signal from the shift register 30 is output to the sampling circuit 32 or not. Specifically, as illustrated in FIG. 3B, the output control circuit 31 includes a plurality of AND gates 33, 34, and 35. A first input terminal of the AND gate is electrically connected to a wiring (hereinafter, also referred to as a source driver control signal line) which supplies a control signal for the source driver (CS(SD)) output from the processor 10. A second input terminal of each AND gate is electrically connected to a wiring supplying an output signal of one of the flip-flops included in the shift register 30. That is, a first input terminal of the AND gate 33 is electrically connected to the source driver control signal line and a second input terminal of the AND gate 33 is electrically connected to a wiring supplying an output signal (FF1out(SD)) of a flip-flop of the first stage included in the shift register 30. Similarly, first input terminals of the AND gate 34 and the AND gate 35 are electrically connected to the source driver control signal line and second terminals of the AND gate 34 and the AND gate 35 are electrically connected to a wiring supplying an output signal (FF2out(SD)) of a flip-flop of the second stage included in the shift register 30 or a wiring supplying an output signal (FF3out(SD)) of a flip-flop of the third stage included in the shift register 30.

The sampling circuit 32 includes a plurality of analog switches (not shown). In the plurality of analog switches, switching is controlled by an output signal of one of a plurality of flip-flops included in the shift register 30. In addition, each analog switch is electrically connected between a wiring supplying an image signal and the pixel portion. That is, switching of the plurality of analog switches is sequentially performed, so that an image signal is input to the plurality of pixels included in the pixel portion.

As described above, by employing a structure in which an image signal input from the source driver 12 to the pixel portion 13 is selected, a region to be subjected to input of an image signal can be selected in a two-dimensional area.

### Modification Example

Note that the above liquid crystal display device is an example of the liquid crystal display device of Embodiment 1. The liquid crystal display device of Embodiment 1 includes a liquid crystal display device having a difference with the above liquid crystal display device.

For example, in the above liquid crystal display device, the pixel portion 13 is divided into two regions which are different in the number of image signals input per unit time. However, the region can be divided into three or more regions.

Further, in the above liquid crystal display device, three images are interpolated between two images formed by image signals input from the outside, for example. However, the number of images for interpolation is not limited to the particular number because the number of images may be determined in accordance with the motion vector detected from two images sequentially displayed.

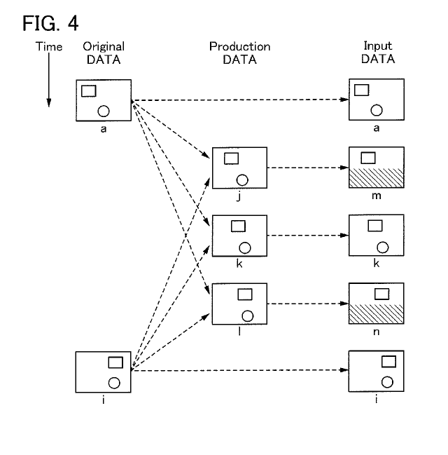

Furthermore, in the above liquid crystal display device, the pixel portion 13 is divided into a region to which an image signal generated for interpolation is input and a region to which the image signal is not input, for example. However, the pixel portion 13 can additionally include a region to which some of image signals generated for interpolation are input. The above description will be explained in detail below with reference to FIG. 4 using the following case as an example: an image signal for forming the image a is input from the outside, and then, an image signal for forming an image i (an image in which a square and a circle are depicted in an upper-right region and a lower-right region, respectively) is input. Note that the difference between the image i and the image b (see FIG. 1B) is the position of the circle. The circle is depicted in the center-right region in the image b while the circle is depicted in the lower-right region in the image i. First, the image a and the image i are compared and a motion vector is detected. Then, image signals are generated to form an image j, an image k, and an image l in accordance with the motion vector. Note that the images j to l are interpolation images of the images a and i. That is, a square and a circle in the image j are moved from the position in the image a to those in the image i by one fourth of the distance between the positions of the square and the circle, the square and the circle in the image k are moved toward the middle between the positions of the square and the circle in the image a and those in the image i, and the square and the circle in the image l are moved from the positions of the square and the circle in the image a toward those in the image i by three fourth of the distance between the positions. Image signals for forming the images are input to the pixel portion. Note that the motion vector is large in the upper region of the pixel portion, whereas the motion vector is small in the lower region of the pixel portion. In this case, it is acceptable that image signals for generating the image j and the image l are input to the upper region of the pixel portion and an image signal for generating the image k is input to an entire region of the pixel portion 13. That is, as illustrated in FIG. 4, an image m, the image k, and an image n are interpolated between the images a and i. Note that the image m and the image n correspond to the upper region of the image j and the upper region of the image l, respectively.

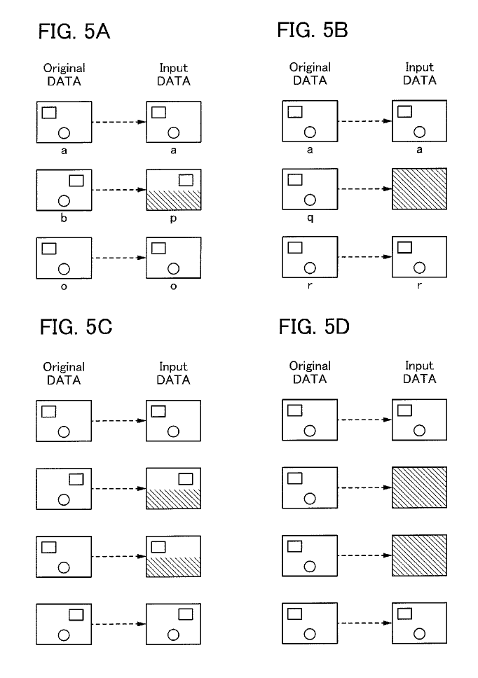

Further, in the above liquid crystal display device, the image signal input from the outside is just input to the pixel portion 13; however, the image signal can be selectively input thereto. For example, as illustrated in FIG. 5A, an image signal for forming the image a and an image signal for forming the image o can be just input from the outside to the pixel portion 13 and an image signal for forming the image b can be selectively input to the pixel portion 13 in the case where the image signal for forming the image a, the image signal for forming the image b, and the image signal for forming the image a (an image in which a square and a circle are depicted in an upper-left region and a lower-center region, respectively) are sequentially input from the outside. That is, as for the image b, the image signal for forming the image b is not input to the pixel portion 13, but instead, an image signal for forming an image p can be input to the pixel portion 13. Note that the image p corresponds to the upper region of the image b. Accordingly, power consumption can be further reduced.

Furthermore, as illustrated in FIG. 5B, it is acceptable that an image signal for forming an image q is not input to the pixel portion 13 in the case where an image signal for forming the image a, the image signal for forming the image q (an image in which a square and a circle are depicted in the upper-left region and the lower-center region, respectively), and an image r (an image in which a square and a circle are depicted in the upper-left region and the lower-center region, respectively) are sequentially input from the outside.

Note that as illustrated in FIGS. 5C and 5D, as for a region or an image in which the motion vector of a plurality of images formed in accordance with image signals input from the outside is small, it is acceptable that image signals are not input to part of or the whole of the pixel portion for the plurality of images.

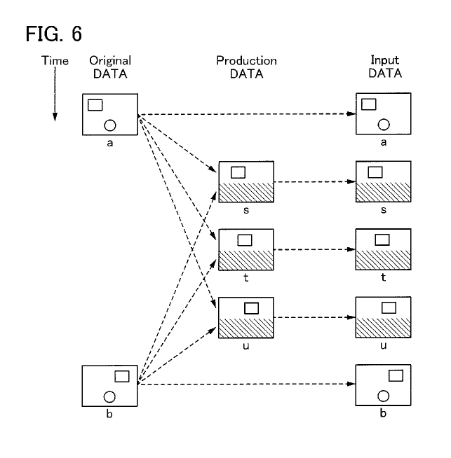

In addition, in the above liquid crystal display device, an image signal (an image signal to the entire region of the pixel portion 13) for forming an interpolation image is generated and the image signal is selectively input to the pixel portion 13. However, a structure of the liquid crystal display device of Embodiment 1 is not limited to this; that is, it is also acceptable that an image signal for forming part of an interpolation image is generated and the image signal is input to the pixel portion 13. For example, as illustrated in FIG. 6, image signals for forming an image s, an image t, and an image u which are images for being interpolated just the upper region (the region 14) of the pixel portion 13 can be generated and the image signals can be input to the pixel portion 13 when the image signals for forming the image a and the image b are input from the outside.

Moreover, the above liquid crystal display device has a structure in which the gate driver 11 (or the source driver 12) includes the shift register and the output control circuit. However, the structure can be replaced with a decoder. Thus, an image signal can be efficiently input to a specific region of the pixel portion 13.

Note that this embodiment or part of this embodiment can be freely combined with any of the other embodiments or part of any of the other embodiments.

### Embodiment 2

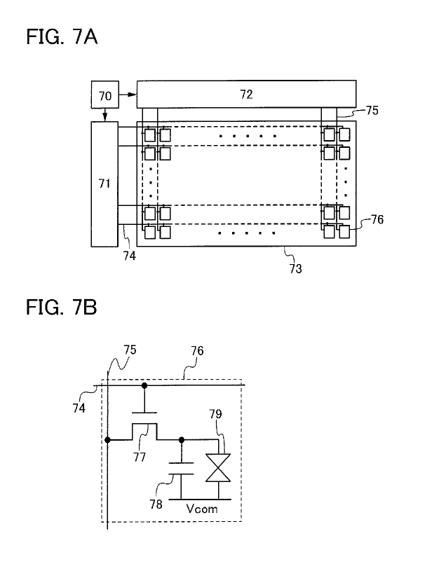

In Embodiment 2, an example of an active matrix liquid crystal display device described in Embodiment 1 will be illustrated in more detail. Specifically, a structure of a pixel portion included in a liquid crystal display device will be described with reference to FIGS. 7A and 7B, FIG. 8, FIGS. 9A and 9B, FIGS. 10A and 10B, FIG. 11, FIGS. 12A to 12D, and FIGS. 13A to 13D.

### <Structure Example of Liquid Crystal Display Device>

A block diagram of a structure of a liquid crystal display device of Embodiment 2 is illustrated in FIG. 7A. The liquid crystal display device illustrated in FIG. 7A includes a processor 70, a gate driver 71, a source driver 72, a pixel portion 73, a plurality of gate lines 74 arranged in parallel, and a plurality of source lines 75 arranged in parallel. Note that the gate driver 71 is electrically connected to the pixel portion 73 through the plurality of gate lines 74, and the source driver 72 is electrically connected to the pixel portion 73 through the plurality of source lines 75.

Further, the pixel portion 73 includes a plurality of pixels 76. Note that the pixels 76 are arranged in matrix. In addition, each of the plurality of gate lines 74 is electrically connected to the plurality of pixels 76 provided in each row, and each of the plurality of source lines 75 is electrically connected to the plurality of pixels 76 provided in each column.

Note that as described in Embodiment 1, in the liquid crystal display device of Embodiment 2, an image signal input from the outside and an image signal for interpolating images, which is formed using the image signal input from the outside, are input to a pixel through the source line 75. Thus, the source line 75 is preferably formed of a low-resistance conductive material in order not to cause a signal delay. For example, the source line 75 is preferably formed of a low-resistance conductive material such as copper (Cu) or an alloy including copper (Cu) as a main structural element. Alternatively, the source line 75 has a stacked-layer structure which includes a layer including copper (Cu) or an alloy including copper (Cu) as a main structural element, so that a signal delay can be suppressed. Similarly, the gate line 74 is preferably formed to have a single layer formed of a low-resistance conductive material such as copper (Cu) or an alloy including copper (Cu) as a main structural element or a stacked-layer structure including the layer.

A circuit diagram of the pixel 76 is illustrated in FIG. 7B. The pixel 76 including a transistor 77 a gate terminal of which is electrically connected to the gate line 74 and a first terminal of which is electrically connected to the source line 75, a capacitor 78 one terminal of which is electrically connected to a second terminal of the transistor 77 and the other terminal of which is electrically connected to a wiring (also referred to as a common potential line) supplying a common potential (Vcom), and a liquid crystal element 79 one terminal of which is electrically connected to the second terminal of the transistor 77 and the one terminal of the capacitor 78 and the other terminal of which is electrically connected to the common potential line. Note that in Embodiment 2, a ground potential, 0 V or the like is given as the common potential (Vcom).

### <Structure Example of Transistor>

As the transistor 77 in Embodiment 2, a thin film transistor whose channel formation region is formed using an oxide semiconductor is employed. As the material of the oxide semiconductor, a four-component metal oxide such as an In—Sn—Ga—Zn—O-based metal oxide, a three-component metal oxide such as an In—Ga—Zn—O-based metal oxide, an In—Sn—Zn—O-based metal oxide, an In—Al—Zn—O-based metal oxide, a Sn—Ga—Zn—O-based metal oxide, an Al—Ga—Zn—O-based metal oxide, and a Sn—Al—Zn—O-based metal oxide, or a two-component metal oxide such as an In—Zn—O-based metal oxide, a Sn—Zn—O-based metal oxide, an Al—Zn—O-based metal oxide, a Zn—Mg—O-based metal oxide, a Sn—Mg—O-based metal oxide, an In—Mg—O-based metal oxide, an In—O-based metal oxide, a Sn—O-based metal oxide, and a Zn—O-based metal oxide can be used. In addition, an oxide semiconductor formed in such a manner that SiO₂ is added to the above oxide semiconductor may be used.

As the oxide semiconductor film, a substance expressed by InMO₃ (ZnO)ₘ (m>0) can be used. Here, M represents one or more metal elements selected from Ga, Al, Mn, and Co. For example, M can be Ga, Ga and Al, Ga and Mn, Ga and Co, or the like. An oxide semiconductor whose composition formula is represented by InMO₃ (ZnO)ₘ (m>0) where Ga is included as M is referred to as the In—Ga—Zn—O oxide semiconductor described above, and a thin film thereof is also referred to as an In—Ga—Zn—O-based film.

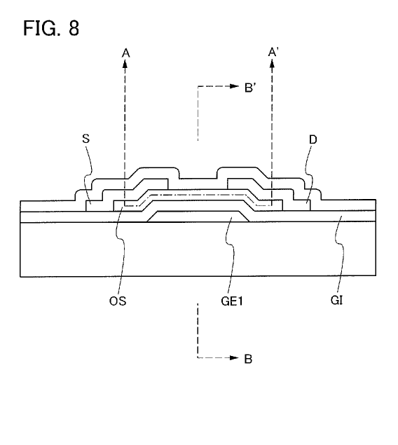

FIG. 8 illustrates a longitudinal cross-sectional view of an inverted staggered thin film transistor including a channel formation region formed using an oxide semiconductor. An oxide semiconductor layer (OS) is provided over a gate electrode layer (GE1) with a gate insulating layer (GI) therebetween, and a source electrode layer (S) and a drain electrode layer (D) are provided thereover.

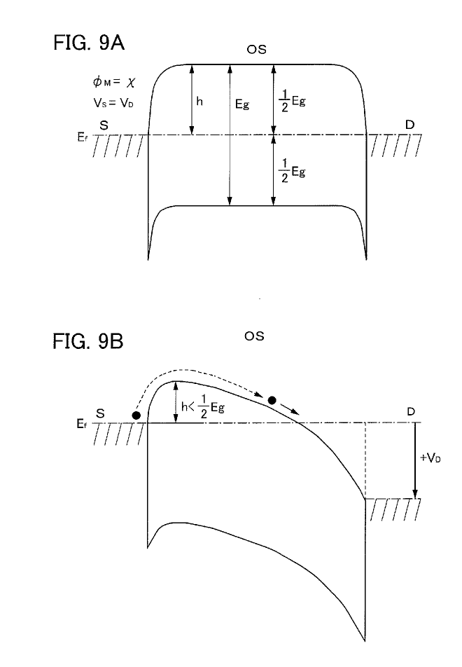

FIGS. 9A and 9B are energy band diagrams (schematic diagrams) of the layers of the thin film transistor in cross section taken along line A-A′ in FIG. 8. FIG. 9A illustrates a case where the source and the drain have voltages of the same potential (V_{D}=0 V). FIG. 9B illustrates a case where a positive potential is applied to the drain (V_{D}>0 V) whereas positive potential is not applied to the source.

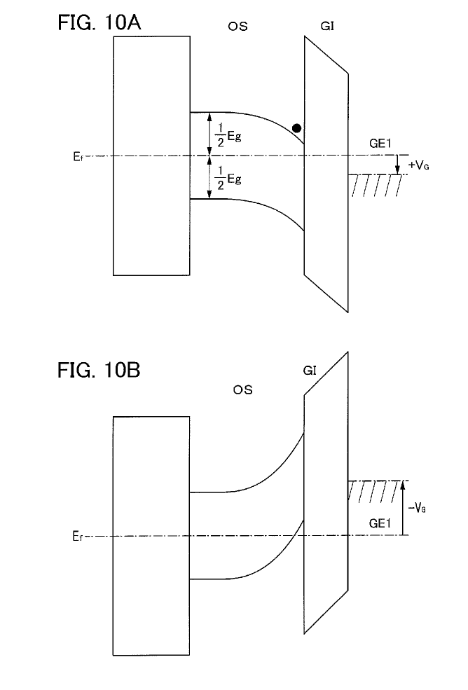

FIGS. 10A and 10B are energy band diagrams (schematic diagrams) of the layers of the thin film transistor in cross section taken along line B-B′ in FIG. 8. FIG. 10A shows a state where a positive potential (+V_{G}) is applied to the gate electrode layer (GE1), that is, an on state where carriers (electrons) flow between the source and the drain. FIG. 10B illustrates a state where a negative potential (−V_{G}) is applied to the gate electrode layer (GE1), that is, an off state (a state where minority carriers do not flow).

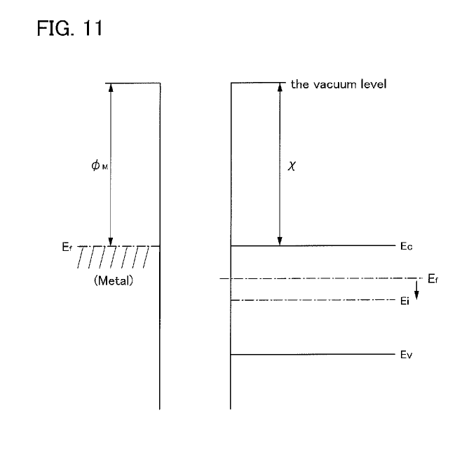

FIG. 11 illustrates relation between the vacuum level and the work function of a metal (φ_{M}) and relation between the vacuum level and the electron affinity of an oxide semiconductor (χ).

In FIG. 11, because metal is degenerated, the conduction band and the Fermi level correspond to each other. On the other hand, a conventional oxide semiconductor is generally n-type, and the Fermi level (E_{f}) in that case is located closer to the conduction band and is away from the intrinsic Fermi level (Ei) that is located in the middle of the band gap. Note that it is known that hydrogen is a donor in an oxide semiconductor, which is known as a factor that causes the oxide semiconductor to be an n-type oxide semiconductor.

In contrast, an oxide semiconductor described here is an intrinsic (i-type) or a substantially intrinsic oxide semiconductor which is obtained by removing hydrogen, which is an n-type impurity, from an oxide semiconductor and highly purifying the oxide semiconductor so that impurities that are not main components of the oxide semiconductor is prevented from being contained therein as much as possible. In other words, a highly purified i-type (intrinsic) semiconductor or a semiconductor close thereto is obtained not by adding an impurity but by removing impurities such as hydrogen or water as much as possible. This enables the Fermi level (E_{f}) to be at the same level as the intrinsic Fermi level (Ei).

It is said that the electron affinity (χ) of an oxide semiconductor is 4.3 eV when the band gap (Eg) thereof is 3.15 eV. The work function of titanium (Ti) used for forming the source electrode layer and the drain electrode layer is substantially equal to the electron affinity (χ) of the oxide semiconductor. In that case, a Schottky barrier for electrons is not formed at an interface between the metal and the oxide semiconductor.

In other words, in the case where the work function of metal (φM) and the electron affinity (χ) of the oxide semiconductor are equal to each other and the metal and the oxide semiconductor are in contact with each other, an energy band diagram (a schematic diagram) as illustrated in FIG. 9A is obtained.

In FIG. 9B, a black circle () represents an electron. When a positive potential is applied to the drain, the electron is injected into the oxide semiconductor layer over the barrier (h) and flows toward the drain. In that case, the height of the barrier (h) changes depending on the gate voltage and the drain voltage; in the case where positive drain voltage is applied, the height of the barrier (h) is smaller than the height of the barrier in FIG. 9A where no voltage is applied, that is, ½ of the band gap (Eg).

In this case, as illustrated in FIG. 10A, the electron moves along the lowest part of the oxide semiconductor, which is energetically stable, at an interface between the gate insulating layer and the highly-purified oxide semiconductor layer.

In FIG. 10B, when a negative potential (reverse bias) is applied to the gate electrode layer (GE1), the number of holes that are minority carriers is substantially zero; thus, the current value becomes a value extremely close to zero.

For example, even when the thin film transistor has a channel width W of 1×10⁴ μm and a channel length of 3 μm, an off current of 10⁻¹³ A or lower and a subthreshold value (S value) of 0.1 V/dec. (the thickness of the gate insulating film: 100 nm) can be obtained.

As described above, the oxide semiconductor is highly purified so that impurities that are not main components of the oxide semiconductor is prevented from being contained therein as much as possible, whereby favorable operation of the thin film transistor can be obtained.

The above oxide semiconductor is an oxide semiconductor which made to be highly purified and which is made to be electrically intrinsic as follows: an impurity such as hydrogen, moisture, a hydroxy group, or hydride (also referred to as a hydrogen compound), which is a factor of the variation in electric characteristics, is intentionally eliminated in order to suppress the variation, and oxygen which is a main component of the oxide semiconductor and which is reduced by an impurity elimination process is supplied.

Accordingly, it is preferable that hydrogen be in the oxide semiconductor as less as possible. It is preferable that hydrogen concentration included in the oxide semiconductor be 1×10¹⁶/cm³ or less and hydrogen included in the oxide semiconductor is reduced as much as possible to be close to zero. Note that the concentration of hydrogen in the oxide semiconductor may be measured by secondary ion mass spectroscopy (SIMS).

Further, the high-purified oxide semiconductor has very few carriers (close to zero) and the carrier density is less than 1×10¹²/cm³, preferably less than 1×10¹¹/cm³. That is, the carrier density of the oxide semiconductor layer is reduced as much as possible to be extremely close to zero. Since there are extremely few carriers in the oxide semiconductor layer, off-state current of a thin film transistor can be low. It is preferable that off-state current be as small as possible. In the above thin film transistor, a current value per 1 μm of the channel width (W) can be 10 aA/μm (1×10⁻¹⁷/μm) or less, further, 1 aA/μm (1×10⁻¹⁸/μm) or less. In general, in a thin film transistor including amorphous silicon, the current value is 1×10⁻¹³ A/μm or more. Further, since there is no pn junction and no hot carrier degradation, electric characteristics of the thin film transistor is not adversely affected.

The oxide semiconductor which is highly purified by drastically removing hydrogen contained in the oxide semiconductor layer as described above is used in a channel formation region of a thin film transistor, whereby a thin film transistor with an extremely small amount of off-state current can be obtained. In addition, in circuit design, the oxide semiconductor layer can be regarded as an insulator when the thin film transistor is in an off state. On the other hand, when the thin film transistor is in an on state, the current supply capability of the oxide semiconductor layer is expected to be higher than the current supply capability of a semiconductor layer formed of amorphous silicon.

When design or the like is performed, it is assumed that the off-state current of a thin film transistor including low-temperature polysilicon is approximately ten thousand times as large as the off-state current of a thin film transistor including an oxide semiconductor. Thus, the voltage holding period of the thin film transistor including an oxide semiconductor can be approximately ten thousand times as long as the voltage holding period of the thin film transistor including low-temperature polysilicon. As an example, when a moving image is displayed at 60 frames per second, holding period of a thin film transistor including an oxide semiconductor for writing one signal can be approximately 160 seconds, which is ten thousand times as long as the holding period of a thin film transistor including low-temperature polysilicon. In this manner, a still image can be displayed in a display portion even by less frequent writing of image signals.

Long holding time allows frequency of supplying an image signal to a pixel to be reduced. In particular, applying the above thin film transistor is very effective for the liquid crystal display device (see FIGS. 5A to 5D) as described in Embodiment 1 in which an image signal input from the outside to a pixel portion selectively. That is, in the liquid crystal display device, although a pixel to which an image signal is not input for a long time exists and the display quality of the pixel possibly deteriorates, the above thin film transistor is used as a switch for controlling input of an image signal to a pixel, whereby the display of the pixel can be held for a long time.

Further, when the thin film transistor is used as a switch for controlling input of an image signal to a pixel, the size of a capacitor provided in a pixel can be reduced. Thus, the aperture ration of the pixel can be high, an image signal can be input to the pixel at high speed, for example.

### <Manufacturing Process Example of Transistor>

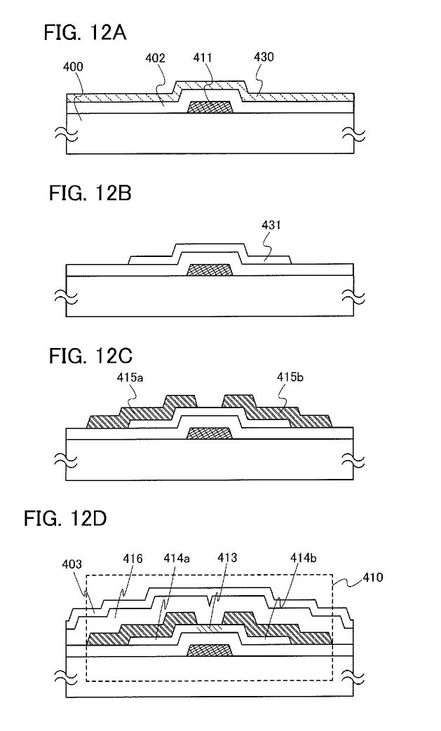

One mode of a manufacturing method of the above thin film transistor is described with reference to FIGS. 12A to 12D.

FIGS. 12A to 12D are figures illustrating an example of a cross-sectional structure of a thin film transistor. A thin film transistor 410 illustrated in FIGS. 12A to 12D is a kind of bottom-gate structure called a channel-etched type and is also called an inverted staggered thin film transistor.

Although a single-gate thin film transistor is illustrated in FIGS. 12A to 12D, a multi-gate thin film transistor including a plurality of channel formation regions can be formed as needed.

A process for manufacturing the thin film transistor 410 over the substrate 400 is described below with reference to FIGS. 12A to 12D.

First, a conductive film is formed over the substrate 400 having an insulating surface, and then, the gate electrode layer 411 is formed through a first photolithography step. Note that a resist mask used in the process may be formed by an inkjet method. Formation of the resist mask by an inkjet method needs no photomask; thus, manufacturing cost can be reduced.

Although there is no particular limitation on a substrate which can be used as the substrate 400 having an insulating surface, it is necessary that the substrate have at least enough heat resistance to withstand heat treatment to be performed later. For example, a glass substrate made of barium borosilicate glass, aluminoborosilicate glass, or the like can be used. In the case where a glass substrate is used and the temperature at which the heat treatment is to be performed later is high, a glass substrate whose strain point is 730° C. or more is preferably used.

Further, an insulating film serving as a base film may be provided between the substrate 400 and the gate electrode layer 411. The base film has a function of preventing diffusion of an impurity element from the substrate 400, and can be formed with a single-layer structure or a stacked-layer structure using one or more of a silicon nitride film, a silicon oxide film, a silicon nitride oxide film, and a silicon oxynitride film.

The gate electrode layer 411 can be formed to have a single-layer or stacked-layer structure using a metal material such as molybdenum, titanium, chromium, tantalum, tungsten, aluminum, copper, neodymium, or scandium, or an alloy material which contains any of these materials as its main component.

For example, as a two-layer structure of the gate electrode layer 411, the following structure is preferable: a structure in which a molybdenum layer is stacked over an aluminum layer, a structure in which a molybdenum layer is stacked over a copper layer, a structure in which a titanium nitride layer or a tantalum nitride layer is stacked over a copper layer, or a structure in which a titanium nitride layer and a molybdenum layer are stacked. As a three-layer structure of the gate electrode layer 411, a three-layer structure of a tungsten layer or a tungsten nitride layer, a layer of an alloy of aluminum and silicon or an alloy of aluminum and titanium, and a titanium nitride layer or a titanium layer is preferable.

Then, a gate insulating layer 402 is formed over the gate electrode layer 411.

The gate insulating layer 402 can be formed to have a single-layer or stacked-layer structure using one or more of a silicon oxide layer, a silicon nitride layer, a silicon oxynitride layer, a silicon nitride oxide layer, an aluminum oxide layer, and the like by plasma CVD, sputtering, or the like. For example, a silicon oxynitride layer may be formed using a deposition gas containing silane (SiH₄), oxygen, and nitrogen by plasma CVD. Furthermore, a high-k material such as hafnium oxide (HfOx) or tantalum oxide (TaOx) can be used as the gate insulating layer. The thickness of the gate insulating layer 402 is 100 nm to 500 nm, inclusive; in the case of a stacked layer, a first gate insulating layer having a thickness of 50 nm to 200 nm, inclusive, and a second gate insulating layer having a thickness of 5 nm to 300 nm, inclusive, are stacked.

In this embodiment, a silicon oxynitride layer having a thickness of 100 nm or less is formed by plasma CVD as the gate insulating layer 402.

Moreover, as the gate insulating layer 402, a silicon oxynitride film may be formed with a high density plasma apparatus. Here, a high-density plasma apparatus refers to an apparatus which can realize a plasma density of 1×10¹¹/cm³ or more. For example, plasma is generated by applying a microwave power of 3 kW to 6 kW inclusive so that the insulating film is formed.

A silane gas (SiH₄), nitrous oxide (N₂O), and a rare gas are introduced into a chamber as a source gas to generate high-density plasma at a pressure of 10 Pa to 30 Pa, and the insulating film is formed over a substrate having an insulating surface, such as a glass substrate. After that, the supply of silane (SiH₄) is stopped, and plasma treatment may be performed on a surface of the insulating film by introducing nitrous oxide (N₂O) and a rare gas without exposure to the air. The plasma treatment performed on the surface of the insulating film by introducing nitrous oxide (N₂O) and a rare gas is performed at least after the insulating film is formed. The insulating film formed through the above process procedure has small thickness and corresponds to an insulating film whose reliability can be ensured even though it has a thickness less than 100 nm, for example.

In forming the gate insulating layer 402, the flow ratio of silane (SiH₄) to nitrous oxide (N₂O) which are introduced into the chamber is in the range of 1:10 to 1:200. In addition, as a rare gas which is introduced into the chamber, helium, argon, krypton, xenon, or the like can be used. In particular, argon, which is inexpensive, is preferably used.

In addition, since the insulating film formed by using the high-density plasma apparatus can have a uniform thickness, the insulating film has excellent step coverage. Further, as for the insulating film formed by using the high-density plasma apparatus, the thickness of a thin film can be controlled precisely.

The insulating film formed through the above process procedure is greatly different from the insulating film formed using a conventional parallel plate plasma CVD apparatus. The etching rate of the insulating film formed through the above process procedure is lower than that of the insulating film formed using the conventional parallel plate plasma CVD apparatus by 10% or more or 20% or more in the case where the etching rates with the same etchant are compared to each other. Thus, it can be said that the insulating film formed using the high-density plasma apparatus is a dense film.

The oxide semiconductor which becomes i-type or becomes substantially i-type (an oxide semiconductor which is highly purified) in a later step is extremely sensitive to an interface state or an interface electric charge; therefore, an interface with the gate insulating layer is important. Therefore, the gate insulating layer (GI) that is in contact with the highly-purified oxide semiconductor needs to have higher quality. Therefore, high-density plasma CVD with use of microwaves (2.45 GHz) is preferably employed since formation of a dense and high-quality insulating film having high withstand voltage can be formed. When the highly-purified oxide semiconductor and the high-quality gate insulating layer are in close contact with each other, the interface state density can be reduced and favorable interface characteristics can be obtained. It is important that an insulating layer has a reduced interface state density with the oxide semiconductor and can form a favorable interface as well as having a favorable layer quality as a gate insulating layer.

Then, an oxide semiconductor film 430 is formed to have a thickness of 2 nm to 200 nm inclusive over the gate insulating layer 402. Note that before the oxide semiconductor film 430 is formed by sputtering, powdery substances (also referred to as particles or dust) which are generated at the time of the film formation and attached on a surface of the gate insulating layer 402 are preferably removed by reverse sputtering in which an argon gas is introduced and plasma is generated. The reverse sputtering refers to a method in which, without application of a voltage to a target side, an RF power supply is used for application of a voltage to a substrate side in an argon atmosphere to modify a surface. Note that instead of an argon atmosphere, a nitrogen atmosphere, a helium atmosphere, an oxygen atmosphere, or the like may be used.

As the oxide semiconductor film 430, an In—Ga—Zn—O-based oxide semiconductor film, an In—Sn—O-based oxide semiconductor film, an In—Sn—Zn—O-based oxide semiconductor film, an In—Al—Zn—O-based oxide semiconductor film, an Sn—Ga—Zn—O-based oxide semiconductor film, an Al—Ga—Zn—O-based oxide semiconductor film, an Sn—Al—Zn—O-based oxide semiconductor film, an In—Zn—O-based oxide semiconductor film, an Sn—Zn—O-based oxide semiconductor film, an Al—Zn—O-based oxide semiconductor film, an In—O-based oxide semiconductor film, an Sn—O-based oxide semiconductor film, or a Zn—O-based oxide semiconductor film is used. In Embodiment 2, the oxide semiconductor film 430 is formed by sputtering with the use of an In—Ga—Zn—O-based metal oxide target. A cross-sectional view at this stage is illustrated in FIG. 12A. Alternatively, the oxide semiconductor film 430 can be formed by sputtering in a rare gas (typically argon) atmosphere, an oxygen atmosphere, or a mixed atmosphere containing a rare gas (typically argon) and oxygen. When a sputtering method is employed, it is preferable that deposition be performed using a target containing SiO₂ of 2 percent by weight to 10 percent by weight and SiOx (x>0) which inhibits crystallization be contained in the oxide semiconductor film 430 so as to prevent crystallization at the time of the heat treatment for dehydration or dehydrogenation in a later step.

In this embodiment, film deposition is performed using a metal oxide target containing In, Ga, and Zn (In₂O₃:Ga₂O₃:ZnO=1:1:1 [mol], In:Ga:Zn=1:1:0.5 [atom]). The deposition condition is the following: the distance between the substrate and the target is 100 mm, the pressure is 0.2 Pa, the direct current (DC) power is 0.5 kW, and the atmosphere is a mixed atmosphere of argon and oxygen (argon: oxygen=30 sccm:20 sccm and the oxygen flow rate is 40%). Note that a pulse direct current (DC) power supply is preferably used because powder substances generated at the time of deposition can be reduced and the film thickness can be made to be uniform. The In—Ga—Zn—O-based film is formed to have a thickness of 5 nm to 200 nm, inclusive. In this embodiment, as the oxide semiconductor film, a 20-nm-thick In—Ga—Zn—O-based film is formed by sputtering with the use of an In—Ga—Zn—O-based oxide semiconductor target. As the metal oxide target containing In, Ga, and Zn, a target having a composition ratio of In:Ga:Zn=1:1:1 (atom %) or a target having a composition ratio of In:Ga:Zn=1:1:2 (atom %) can also be used.

Examples of sputtering include RF sputtering in which a high-frequency power supply is used as a sputtering power supply, DC sputtering, and pulsed DC sputtering in which a bias is applied in a pulsed manner. RF sputtering is mainly used in the case where an insulating film is formed, and DC sputtering is mainly used in the case where a metal film is formed.

In addition, there is also a multi-source sputtering apparatus in which a plurality of targets of different materials can be set. With the multi-source sputtering apparatus, films of different materials can be formed to be stacked in the same chamber, or a film of plural kinds of materials can be formed by electric discharge at the same time in the same chamber.

In addition, there are a sputtering apparatus provided with a magnet system inside the chamber and used for a magnetron sputtering, and a sputtering apparatus used for an ECR sputtering in which plasma generated with the use of microwaves is used without using glow discharge.

Furthermore, as a deposition method by sputtering, there are also reactive sputtering in which a target substance and a sputtering gas component are chemically reacted with each other during deposition to form a thin compound film thereof, and a bias sputtering in which voltage is also applied to a substrate during deposition.

Then, the oxide semiconductor film 430 is processed into an island-shaped oxide semiconductor layer through a second photolithography step. Note that a resist mask used in the process may be formed by an inkjet method. Formation of the resist mask by an inkjet method needs no photomask; thus, manufacturing cost can be reduced.

Next, dehydration or dehydrogenation of the oxide semiconductor layers is performed. The temperature of first heat treatment for dehydration or dehydrogenation is 400° C. to 750° C. inclusive, preferably 400° C. or more and lower than the strain point of the substrate. Here, the substrate is introduced into an electric furnace which is one of heat treatment apparatuses, heat treatment is performed on the oxide semiconductor layer in a nitrogen atmosphere at 450° C. for one hour, and then, the oxide semiconductor layer is not exposed to the air so that entry of water and hydrogen into the oxide semiconductor layer is prevented; thus, an oxide semiconductor layer 431 is obtained (see FIG. 12B).

Note that a heat treatment apparatus is not limited to an electrical furnace, and may include a device for heating an object by heat conduction or heat radiation from a heating element such as a resistance heating element. For example, an RTA (rapid thermal anneal) apparatus such as a GRTA (gas rapid thermal anneal) apparatus or an LRTA (lamp rapid thermal anneal) apparatus can be used. An LRTA apparatus is an apparatus for heating an object by radiation of light (an electromagnetic wave) emitted from a lamp such as a halogen lamp, a metal halide lamp, a xenon arc lamp, a carbon arc lamp, a high pressure sodium lamp, or a high pressure mercury lamp. A GRTA apparatus is an apparatus for heat treatment using a high-temperature gas. As the gas, an inert gas which does not react with an object by heat treatment, such as nitrogen or a rare gas such as argon is used.

For example, as the first heat treatment, GRTA by which the substrate is moved into an inert gas heated to a high temperature as high as 650° C. to 700° C., heated for several minutes, and moved out of the inert gas heated to the high temperature may be performed. With GRTA, high-temperature heat treatment for a short period of time can be achieved.

Note that in the first heat treatment, it is preferable that water, hydrogen, and the like be not contained in the atmosphere of nitrogen or a rare gas such as helium, neon, or argon. Alternatively, it is preferable that the purity of nitrogen or the rare gas such as helium, neon, or argon which is introduced into the heat treatment apparatus be 6N (99.9999%) or more, preferably 7N (99.99999%) or more (that is, the impurity concentration is 1 ppm or less, preferably 0.1 ppm or less).

The first heat treatment of the oxide semiconductor layer may be performed on the oxide semiconductor film 430 before being processed into the island-shaped oxide semiconductor layer. In that case, after the first heat treatment, the substrate is extracted from the heat treatment apparatus, and then the second photolithography step is performed.

The heat treatment for dehydration or dehydrogenation of the oxide semiconductor layers may be performed at any of the following timings: after the oxide semiconductor layer is formed; after a source electrode layer and a drain electrode layer are formed over the oxide semiconductor layer; and after a protective insulating film is formed over the source electrode layer and the drain electrode layer.

Further, the step of forming the opening portion in the gate insulating layer 402 may be performed either before or after the oxide semiconductor film 430 is subjected to dehydration or dehydrogenation treatment.

Note that the etching of the oxide semiconductor film 430 is not limited to wet etching and dry etching may also be used.

As the etching gas for dry etching, a gas including chlorine (chlorine-based gas such as chlorine (Cl₂), boron chloride (BCl₃), silicon chloride (SiCl₄), or carbon tetrachloride (CCl₄)) is preferably used.

Alternatively, a gas containing fluorine (fluorine-based gas such as carbon tetrafluoride (CF₄), sulfur fluoride (SF₆), nitrogen fluoride (NF₃), or trifluoromethane (CHF₃)); hydrogen bromide (HBr); oxygen (O₂); any of these gases to which a rare gas such as helium (He) or argon (Ar) is added; or the like can be used.

As the dry etching, parallel plate RIE (reactive ion etching) or ICP (inductively coupled plasma) etching can be performed. In order to etch the films into desired shapes, the etching conditions (the amount of electric power applied to a coil-shaped electrode, the amount of electric power applied to an electrode on the substrate side, the temperature of the electrode on the substrate side, or the like) is adjusted as appropriate.

As an etchant used for wet etching, a mixed solution of phosphoric acid, acetic acid, and nitric acid, or the like can be used. In addition, ITO07N (produced by KANTO CHEMICAL CO., INC.) may also be used.

The etchant after the wet etching is removed together with the etched materials by cleaning. The waste liquid of the etchant including the material etched off may be purified and the included material may be reused. When a material such as indium included in the oxide semiconductor layer is collected from the waste liquid after the etching and reused, the resources can be efficiently used and the cost can be reduced.

The etching conditions (such as an etchant, etching time, or temperature) are appropriately adjusted depending on the material so that the material can be etched into a desired shape.

Next, a metal conductive film is formed over the gate insulating layer 402 and the oxide semiconductor layer 431. The metal conductive film may be formed by sputtering or vacuum evaporation. As a material of the metal conductive film, an element selected from aluminum (Al), chromium (Cr), copper (Cu), tantalum (Ta), titanium (Ti), molybdenum (Mo), and tungsten (W), an alloy containing any of these elements as a component, an alloy containing any of these the elements in combination, or the like can be given. Alternatively, one or more materials selected from manganese (Mn), magnesium (Mg), zirconium (Zr), beryllium (Be), and yttrium (Y) may be used. Further, the metal conductive film may have a single-layer structure or a stacked-layer structure of two or more layers. For example, the following structures can be given: a single layer structure of an aluminum film including silicon, a single layer structure of a copper film, or a film including copper as a main component, a stacked-layer structure in which a titanium film is stacked over an aluminum film, a stacked-layer structure in which a copper film is formed over a tantalum nitride film or a copper nitride film, and a stacked-layer structure in which an aluminum film is stacked over a titanium film and a titanium film is stacked over the aluminum film. Alternatively, a film, an alloy film, or a nitride film which contains aluminum (Al) and one or a plurality of elements selected from titanium (Ti), tantalum (Ta), tungsten (W), molybdenum (Mo), chromium (Cr), neodymium (Nd), and scandium (Sc) may be used.

If heat treatment is performed after formation of the metal conductive film, it is preferable that the metal conductive film have enough heat resistance to withstand the heat treatment.

A third photolithography step is performed. A resist mask is formed over the metal conductive film and etching is selectively performed, so that the source electrode layer 415a and the drain electrode layer 415b are formed. Then, the resist mask is removed (see FIG. 12C).

Note that materials and etching conditions are adjusted as appropriate so that the oxide semiconductor layer 431 is not removed by etching of the metal conductive film.

In Embodiment 2, a titanium film is used as the metal conductive film, an In—Ga—Zn—O based oxide is used for the oxide semiconductor layer 431, and an ammonia hydrogen peroxide solution (a mixture of ammonia, water, and a hydrogen peroxide solution) is used as an etchant.

Note that, in the third photolithography step, only a part of the oxide semiconductor layer 431 is etched, whereby oxide semiconductor layer having groove (depressed portions) are formed in some cases. Alternatively, the resist mask used in the process may be formed by an inkjet method. Formation of the resist mask by an inkjet method needs no photomask; thus, manufacturing cost can be reduced.

In order to reduce the number of photomasks used in a photolithography step and reduce the number of photolithography steps, an etching step may be performed with the use of a resist mask formed using a multi-tone mask which is a light-exposure mask through which light is transmitted to have a plurality of intensities. Since a resist mask formed using a multi-tone mask has a plurality of thicknesses and can be further changed in shape by performing ashing, the resist mask can be used in a plurality of etching steps to provide different patterns. Therefore, a resist mask corresponding to at least two kinds or more of different patterns can be formed by one multi-tone mask. Thus, the number of light-exposure masks and the number of corresponding photolithography steps can be reduced, whereby simplification of a process can be realized.

Then, plasma treatment with a gas such as nitrous oxide (N₂O), nitrogen (N₂), or argon (Ar) is performed. By this plasma treatment, absorbed water and the like attached to an exposed surface of the oxide semiconductor layer are removed. Plasma treatment may be performed using a mixture gas of oxygen and argon as well.

After the plasma treatment, the oxide insulating layer 416 which serves as a protective insulating film and is in contact with part of the oxide semiconductor layer is formed without exposure to the air.

The oxide insulating layer 416, which has a thickness of at least 1 nm or more, can be formed as appropriate by sputtering or the like, that is a method by which impurities such as water and hydrogen are not mixed into the oxide insulating layer 416. When hydrogen is contained in the oxide insulating layer 416, entry of the hydrogen to the oxide semiconductor layer is caused, thereby making a backchannel of the oxide semiconductor layer 431 have a lower resistance (have n-type conductivity) and forming parasitic channels. Therefore, it is important that a formation method in which hydrogen is not used is employed in order to form the oxide insulating layer 416 containing as little hydrogen as possible.

In Embodiment 2, a 200-nm-thick silicon oxide film is deposited as the oxide insulating layer 416 by sputtering. The substrate temperature in film formation may be a room temperature or more and 300° C. or less and in Embodiment 2, is 100° C. Formation of a silicon oxide film by sputtering can be performed in a rare gas (typically, argon) atmosphere, an oxygen atmosphere, or an atmosphere of a rare gas (typically, argon) and oxygen. As a target, a silicon oxide target or a silicon target may be used. For example, the silicon oxide film can be formed using a silicon target by sputtering in an atmosphere containing oxygen and nitrogen.

Next, second heat treatment is performed in an inert gas atmosphere or oxygen gas atmosphere (preferably at 200° C. to 400° C., inclusive, e.g., 250° C. to 350° C., inclusive). For example, the second heat treatment is performed in a nitrogen atmosphere at 250° C. for one hour. Through the second heat treatment, part of the oxide semiconductor layer (a channel formation region) is heated while being in contact with the oxide insulating layer 416. Thus, oxygen is supplied to part of the oxide semiconductor layer (a channel formation region).

Through the above steps, the oxide semiconductor layer is subjected to the heat treatment for dehydration or dehydrogenation, and then, part of the oxide semiconductor layer (a channel formation region) is selectively made to be in an oxygen excess state. As a result, a channel formation region 413 overlapping with the gate electrode layer 411 becomes i-type, and a source region 414a overlapping with the source electrode layer 415a and a drain region 414b overlapping with the drain electrode layer 415b are formed in a self-aligned manner. Thus, the thin film transistor 410 is formed.

When an oxide semiconductor containing an impurity is subjected to a gate bias-temperature stress test (BT test) for 12 hours under conditions that the temperature is 85° C. and the voltage applied to the gate is 2×10⁶ V/cm, a bond between the impurity and a main component of the oxide semiconductor is cleaved by a high electric field (B: bias) and a high temperature (T: temperature), and a generated dangling bond induces shift of threshold voltage (Vth). On the other hand, by removing impurities in an oxide semiconductor as much as possible, especially hydrogen or water and performing the above high-density plasma CVD, so that a dense and high-quality insulating film with high withstand voltage and good interface characteristics between the insulating film and an oxide semiconductor as described above can be obtained; thus, a thin film transistor which is stable even in the BT test can be obtained.

Further, heat treatment may be performed at 100° C. to 200° C. inclusive for from 1 hour to 30 hours inclusive in the air. In this embodiment, the heat treatment is performed at 150° C. for 10 hours. This heat treatment may be performed at a fixed heating temperature. Alternatively, the following change in the heating temperature may be conducted plural times repeatedly: the heating temperature is increased from a room temperature to a temperature of 100° C. to 200° C. inclusive and then decreased to a room temperature. Further, this heat treatment may be performed before formation of the oxide insulating film under a reduced pressure. Under the reduced pressure, the heat treatment time can be shortened. By the heat treatment, hydrogen is taken in the oxide insulating layer from the oxide semiconductor layer.

By the formation of the drain region 414b in part of the oxide semiconductor layer, which overlaps with the drain electrode layer 415b, reliability of the thin film transistor can be improved. Specifically, by the formation of the drain region 414b, a structure in which conductivity can be varied from the drain electrode layer 415b to the channel formation region 413 through the drain region 414b can be obtained. Thus, because the drain region 414b serves as a buffer, a localized high electric field is not applied to the transistor even when a high electric field is applied between the gate electrode layer 411 and the drain electrode layer 415b, so that the transistor can have increased withstand voltage.

Further, the source region or the drain region in the oxide semiconductor layer is formed in the entire thickness direction in the case where the thickness of the oxide semiconductor layer is 15 nm or less. In the case where the thickness of the oxide semiconductor layer is 30 nm to 50 nm inclusive, in part of the oxide semiconductor layer, that is, in a region in the oxide semiconductor layer, which is in contact with the source electrode layer or the drain electrode layer, and the vicinity thereof, resistance is reduced and the source region or the drain region is formed, while a region in the oxide semiconductor layer, which is close to the gate insulating layer, can be made to be i-type.

A protective insulating layer may be additionally formed over the oxide insulating layer 416. For example, a silicon nitride film is formed by RF sputtering. Since RF sputtering realizes high productivity, it is preferably used as a film formation method of the protective insulating layer. The protective insulating layer 403 is formed using an inorganic insulating film which does not contain impurities such as moisture, a hydrogen ion, and OH⁻ and blocks entry of these impurities from the outside; for example, a silicon nitride film, an aluminum nitride film, a silicon nitride oxide film, an aluminum oxynitride film, or the like is used. In Embodiment 2, as the protective insulating layer, a protective insulating layer 403 is formed using a silicon nitride film (see FIG. 12D).

### Modification Example

The above liquid crystal display device is an example of a liquid crystal display device in Embodiment 2, and Embodiment 2 includes a liquid crystal display device having a difference with the above liquid crystal display device.

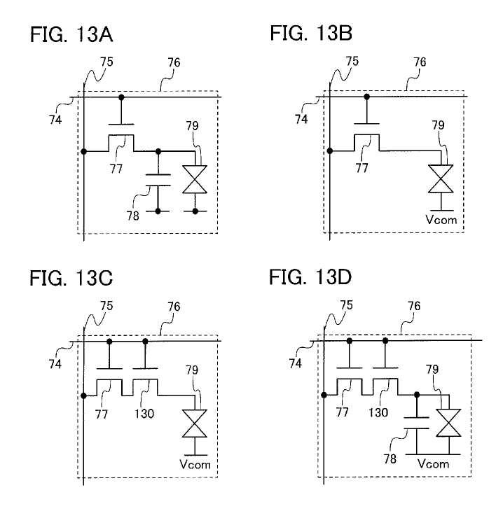

For example, in the above liquid crystal display device, the pixel is formed using the circuit illustrated in FIG. 7B; however, the pixel can have any of pixel structures illustrated in FIGS. 13A to 13D.

A circuit illustrated in FIG. 13A is different from that in FIG. 7B in that the other terminal of the capacitor 78 and the other terminal of the liquid crystal element 79 are electrically connected to different wirings. In the circuit in FIG. 7B, it becomes possible to control a voltage applied to the liquid crystal element 79 by controlling a potential of the wiring electrically connected to the other terminal of the capacitor 78.

A circuit illustrated in FIG. 13B is different from that in FIG. 7B in that the capacitor 78 is not provided. The off-state current of the above thin film transistor (see FIG. 12) is extremely low. That is, the variation of the voltage applied to the liquid crystal element 79 can be suppressed even when the capacitor 78 is not provided. Accordingly, the pixel 76 can hold display even when the capacitor 78 is not provided. Note that in the structure, since leakage of charge through the liquid crystal element 79 considerably affects the voltage applied to the liquid crystal element 79 itself, a liquid crystal material used for the liquid crystal element 79 is preferably a material with a high specific resistance. Specifically, the specific resistance of the liquid crystal material is preferably 1×10¹¹Ω·cm or more, more preferably 1×10¹²Ω·cm or more. In addition, in a pixel in FIG. 13B, improvement of the aperture ratio, high-speed input of an image signal, or the like can be realized.

A circuit illustrated in FIG. 13C has a structure in which a transistor 130 is added to the circuit in FIG. 13B. The structure can lead to further reduction of the variation of the voltage applied to the liquid crystal element 79.

A circuit illustrated in FIG. 13D has a structure in which the transistor 130 is added to the circuit in FIG. 7B. The structure can lead to further reduction in the variation of the voltage applied to the liquid crystal element 79.

Moreover, in the above liquid crystal display device, a thin film transistor called a channel etched transistor, which is one kind of bottom gate structure. However, the structure of the thin film transistor is not limited to a particular structure. For example, the thin film transistor can have one kind of bottom gate structure called a channel stop type, a top gate structure, or the like. Further, the thin film transistor can have a structure in which gate electrode layers are provided below and over the channel formation region.

Note that this embodiment or part of this embodiment can be freely combined with the other embodiments or part of the other embodiments.

### Embodiment 3

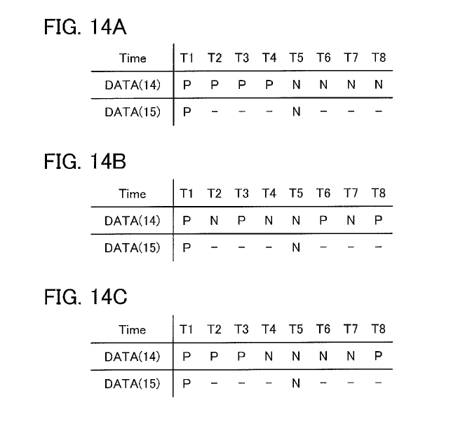

In Embodiment 3, an example of an active matrix liquid crystal display device described in Embodiment 1 will be illustrated in more detail. Specifically, an example of inversion driving performed in the liquid crystal display device will be described with reference to FIGS. 14A to 14C, FIGS. 15A and 15B, FIGS. 16A to 16C, and FIG. 17. Note that here, as illustrated in FIG. 1A, image signals are input to a pixel group (the pixels 141, 142, 143, 144, and the like) included in the region 14 four times per unit time, and image signals are input to a pixel group (the pixel 151, 152, 153, 154, and the like) included in the region 15 one time per unit time. Further, each pixel has the circuit structure illustrated in FIG. 7B.

FIGS. 14A to 14C illustrate an example of polarities of an image signal (DATA(14)) input to a pixel included in the region 14 illustrated in FIG. 1A and an image signal (DATA(15)) input to a pixel included in the region 15 illustrated in FIG. 1A. Note that in FIGS. 14A to 14C, the case where an image signal input to one terminal of the liquid crystal element 79 illustrated in FIG. 7B has a potential higher than common potential (Vcom) and the case where an image signal input to one terminal of the liquid crystal element 79 illustrated in FIG. 7B has a potential lower than the common potential (Vcom) are expressed “P” and “N”, respectively. In addition, “T1” to “T8” have the same length and are successive periods.

As illustrated in FIGS. 14A to 14C, the number of “P”s and the number of “N”s are controlled to be the same in a certain period (here, “T1” to “T8”), so that deterioration of the liquid crystal element 79 can be suppressed. Further, when an image data is also input to the region where the number of image signals input per unit time (here, “T1” to “T4” or “T5” to “T8”) is different (here, “T1” or “T5”), the polarities of image signals input to the regions is preferably the same. That is, when image signals are input to the entire pixel portion, the polarities of the image signals are preferably the same. Therefore, the image signal is not changed with crossing the common potential (Vcom) in the period (here, “T1” or “T5”). That is, an increase of power consumption accompanying with an input of the image signal can be suppressed to be as little as possible.

Further, when the inversion driving is performed, as illustrated in FIGS. 14A to 14C, the order of “P” and “N” can be designed arbitrarily as long as the number of “P”s and the number of “N”s are the same in a certain period. For example, when the main purpose is reduction in power consumption, it is preferable that the polarity of an image signal be inverted as little as possible. Specifically, it is preferable to design the order as illustrated in FIG. 14A. In contrast, when the main purpose is improvement in quality of a displayed image (or a moving image), it is preferable that the polarity of an image signal be inverted as much as possible. Specifically, it is preferable to design as illustrated in FIG. 14B.

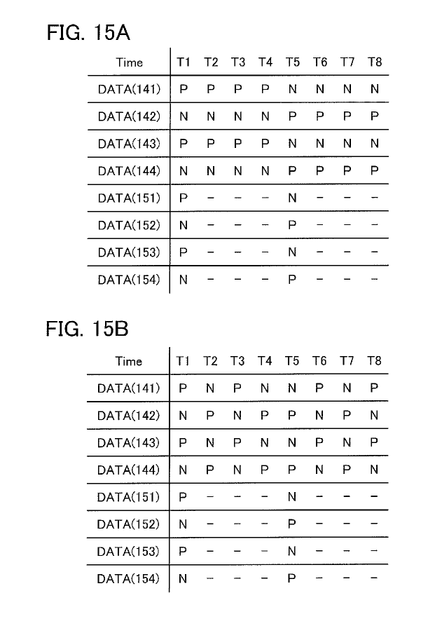

Furthermore, the inversion driving in which the polarity of image data is inverted every specific region of the pixel portion is preferably performed in addition to the above inversion driving (in a certain period, a plurality of image signals is input to a pixel, the plurality of image signals includes an image signal with a potential higher than a common potential (Vcom) and an image signal with a potential lower than a common potential (Vcom), and the number of the former and that of the latter are the same). First, the case where inversion driving is performed every column on a plurality of pixels arranged in matrix will be described with reference to FIGS. 15A and 15B.

FIGS. 15A and 15B illustrate an example of the polarities of image signals input to the pixel 141 (DATA(141)) to the pixel 144 (DATA(144)) and image signals input to the pixel 151 (DATA(151)) to the pixel 154 (DATA(154)). As illustrated in FIGS. 15A and 15B, quality of a displayed image (or a moving image) is improved by inversion of the polarity of an image signal input to an adjacent pixel.

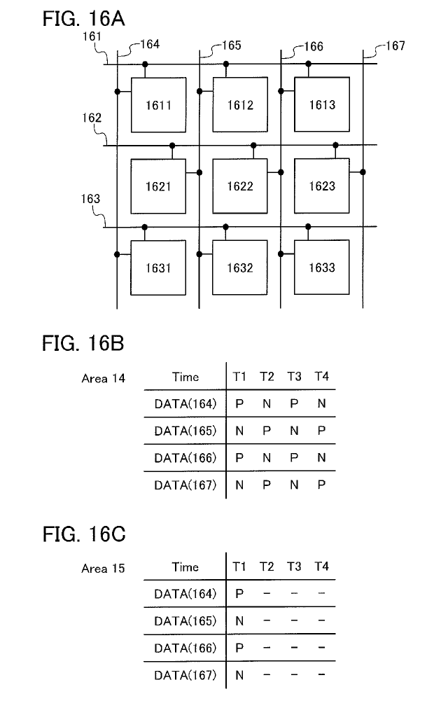

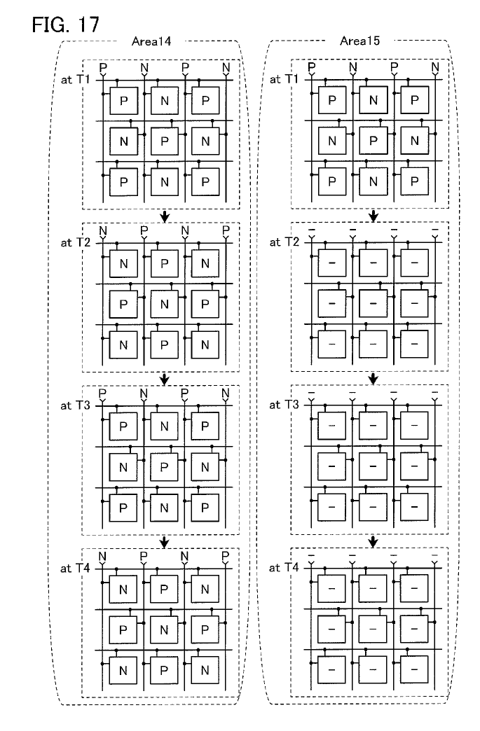

Then, the case where inversion driving is performed on each of a plurality of pixels arranged in matrix in addition to the above inversion driving (in a certain period, a plurality of image signals is input to a pixel, the plurality of image signals includes an image signal with a potential higher than a common potential (Vcom) and an image signal with a potential lower than a common potential (Vcom), and the number of the former and that of the latter are the same) will be described with reference to FIGS. 16A to 16C and FIG. 17.

FIG. 16A illustrates a specific structure of part of the pixel portion. Specifically, FIG. 16A illustrates nine pixels and wirings electrically connected to the pixels. A pixel 1611 is electrically connected to a gate line 161 and a source line 164. A pixel 1612 is electrically connected to the gate line 161 and a source line 165. A pixel 1613 is electrically connected to the gate line 161 and a source line 166. A pixel 1621 is electrically connected to a gate line 162 and the source line 165. A pixel 1622 is electrically connected to the gate line 162 and the source line 166. A pixel 1623 is electrically connected to the gate line 162 and a source line 167. A pixel 1631 is electrically connected to a gate line 163 and the source line 164. A pixel 1632 is electrically connected to the gate line 163 and the source line 165. A pixel 1633 is electrically connected to the gate line 163 and the source line 166.

Further, the polarities of image signals input to the source lines 164 to 167 illustrated in FIG. 16A are alternately inverted. That is, when a pixel group illustrated in FIG. 16A is a pixel group included in the region 14 illustrated in FIG. 1A, image signals are input as illustrated in FIG. 16B; and when a pixel group illustrated in FIG. 16A is a pixel group included in the region 15 illustrated in FIG. 1A, image signals are input as illustrated in FIG. 16C. Note that in FIGS. 16B and 16C, DATA(164) represents an image signal input to a pixel through the source line 164 and the same applies to DATA(165) to DATA(167).

In a pixel structure illustrated in FIG. 16A, an image signal is input as illustrated in FIG. 16B or 16C, so that an image signal is input to each pixel as illustrated in FIG. 17. That is, it is possible to perform inversion driving on each pixel. The inversion driving can lead to improvement of the quality of a displayed image (or a moving image).

Note that this embodiment or part of this embodiment can be freely combined with the other embodiments or part of the other embodiments.

### Embodiment 4

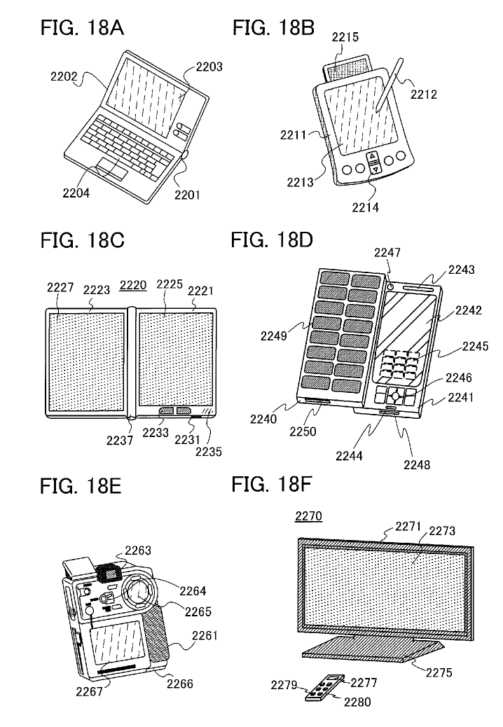

In Embodiment 4, examples of an electronic appliance on which a liquid crystal display device obtained in Embodiments above is mounted are described with reference to FIGS. 18A to 18F. Note that the liquid crystal display device according to the above Embodiments is used for a display portion of an electronic device.

FIG. 18A illustrates a laptop computer, which includes a main body 2201, a housing 2202, a display portion 2203, a keyboard 2204, and the like.

FIG. 18B illustrates a portable information terminal device (PDA), which includes a main body 2211 provided with a display portion 2213, an external interface 2215, an operation button 2214, and the like. A stylus 2212 for operation is included as an accessory.

FIG. 18C illustrates an e-book reader 2220 as an example of an electronic paper. The e-book reader 2220 includes two housings, a housing 2221 and a housing 2223. The housings 2221 and 2223 are bound with each other by an axis portion 2237, along which the e-book reader 2220 can be opened and closed. With such a structure, the e-book reader 2220 can be used as paper books.

A display portion 2225 is incorporated in the housing 2221, and a display portion 2227 is incorporated in the housing 2223. The display portion 2225 and the display portion 2227 may display one image or different images. In the structure where the display portions display different images from each other, for example, the right display portion (the display portion 2225 in FIG. 18C) can display text and the left display portion (the display portion 2227 in FIG. 18C) can display images.

Further, in FIG. 18C, the housing 2221 is provided with an operation portion and the like. For example, the housing 2221 is provided with a power supply 2231, an operation key 2233, a speaker 2235, and the like. With the operation key 2233, pages can be turned. Note that a keyboard, a pointing device, or the like may also be provided on the surface of the housing, on which the display portion is provided. Furthermore, an external connection terminal (an earphone terminal, a USB terminal, a terminal that can be connected to various cables such as an AC adapter and a USB cable, or the like), a recording medium insertion portion, and the like may be provided on the back surface or the side surface of the housing. Further, the e-book reader 2220 may have a function of an electronic dictionary.

The e-book reader 2220 may be configured to transmit and receive data wirelessly. Through wireless communication, desired book data or the like can be purchased and downloaded from an e-book reader server.

Note that electronic paper can be used for electronic appliances in all fields as long as they display data. For example, electronic paper can be used for, instead of e-book reader, posters, advertisement in vehicles such as trains, display in a variety of cards such as credit cards, and so on.

FIG. 18D illustrates a mobile phone, which includes two housings: a housing 2240 and a housing 2241. The housing 2241 is provided with a display panel 2242, a speaker 2243, a microphone 2244, a pointing device 2246, a camera lens 2247, an external connection terminal 2248, and the like. The housing 2240 is provided with a solar cell 2249 charging of the mobile phone, an external memory slot 2250, and the like. An antenna is incorporated in the housing 2241.

The display panel 2242 has a touch panel function. A plurality of operation keys 2245 which is displayed as images is illustrated by dashed lines in FIG. 18D. Note that the mobile phone includes a booster circuit for increasing a voltage output from the solar cell 2249 to a voltage needed for each circuit. Further, in addition to the above structure, a contactless IC chip, a small memory device, or the like may be incorporated.

The display orientation of the display panel 2242 changes as appropriate in accordance with the application mode. Further, the camera lens 2247 is provided on the same surface as the display panel 2242, and thus, it can be used as a video phone. The speaker 2243 and the microphone 2224 can be used for videophone calls, recording, and playing sound, etc. as well as voice calls. Moreover, the housings 2240 and 2241 in a state where they are developed as illustrated in FIG. 18D can be slid so that one is lapped over the other; therefore, the size of the mobile phone can be reduced, which makes the mobile phone suitable for being carried.

The external connection terminal 2248 can be connected to an AC adapter or a variety of cables such as a USB cable, which enables charging of the mobile phone and data communication between the mobile phone and the like. Moreover, a larger amount of data can be saved and moved by inserting a recording medium to the external memory slot 2250. Further, in addition to the above functions, an infrared communication function, a television reception function, or the like may be provided.

FIG. 18E illustrates a digital camera, which includes a main body 2261, a display portion (A) 2267, an eyepiece 2263, an operation switch 2264, a display portion (B) 2265, a battery 2266, and the like.

FIG. 18F illustrates a television set 2270, which includes a display portion 2273 incorporated in a housing 2271. The display portion 2273 can display images. Here, the housing 2271 is supported by a stand 2275.

The television set 2270 can be operated by an operation switch of the housing 2271 or a separate remote controller 2280. Channels and volume can be controlled with an operation key 2279 of the remote controller 2280 so that an image displayed in the display portion 2273 can be controlled. Moreover, the remote controller 2280 may have a display portion 2227 in which the information outgoing from the remote controller 2280 is displayed.

Note that the television set 2270 is preferably provided with a receiver, a modem, and the like. With the receiver, a general television broadcast can be received. Furthermore, when the television set 2270 is connected to a communication network by wired or wireless connection through the modem, one-way (from a transmitter to a receiver) or two-way (between a transmitter and a receiver, between receivers, or the like) data communication can be performed.

This application is based on Japanese Patent Application serial no. 2009-276269 filed with the Japan Patent Office on Dec. 4, 2009, the entire contents of which are hereby incorporated by reference.

What is claimed is:

1. A display device comprising:
a processor configured to compare a first image and a second image formed in accordance with image signals input from the outside and generates an image signal for forming a third image for being interpolated between the first image and the second image;
a gate driver and a source driver whose operations are controlled by an output signal of the processor; and
a pixel portion where display is performed by output signals of the gate driver and the source driver,
wherein the pixel portion comprising a plurality of a thin film transistor using a oxide semiconductor film as a channel formation region is divided into a plurality of regions and whether an image signal for forming the third image is input or not is selected depending on a region of the plurality of regions.

2. The display device according to the claim 1,
wherein the gate driver comprises:
a shift register including a flip-flop; and
an output control circuit to which an output signal of the flip-flop is input,
wherein the output control circuit comprises an AND gate with a first input terminal to which an output signal of the processor is input and a second input terminal to which an output signal of the flip-flop is input.

3. The display device according to the claim 1,
wherein the source driver comprises:
a shift register including a flip-flop;
an output control circuit to which an output signal of the flip-flop is input; and
a sampling circuit to which an output signal of the output control circuit is input,
wherein the output control circuit comprises an AND gate with a first input terminal to which an output signal of the processor is input and a second input terminal to which an output signal of the flip-flop is input.

4. The display device according to the claim 1,
wherein carrier density of the oxide semiconductor film is less than 1×10¹²/cm³.

5. The display device according to the claim 1,
wherein hydrogen concentration of the oxide semiconductor film is less than 1×10¹⁶/cm³.

6. The display device according to the claim 1, wherein the display device is a liquid crystal display device.

7. A display device comprising:
a processor configured to compare a first image and a second image formed in accordance with image signals input from the outside and generates image signals for forming a third image to an n-th image (n is a natural number of 4 or more) which are to be interpolated between the first image and the second image;
a gate driver and a source driver whose operations are controlled by an output signal of the processor; and
a pixel portion where display is performed by output signals of the gate driver and the source driver,
wherein the pixel portion comprising a plurality of a thin film transistor using a oxide semiconductor film as a channel formation region is divided into a plurality of regions and whether the image signals for forming the third image to the n-th image are input or not is selected depending on a region of the plurality of regions.

8. The display device according to the claim 7,
wherein the gate driver comprises:
a shift register including a flip-flop; and
an output control circuit to which an output signal of the flip-flop is input,
wherein the output control circuit comprises an AND gate with a first input terminal to which an output signal of the processor is input and a second input terminal to which an output signal of the flip-flop is input.

9. The display device according to the claim 7,
wherein the source driver comprises:
a shift register including a flip-flop;
an output control circuit to which an output signal of the flip-flop is input; and
a sampling circuit to which an output signal of the output control circuit is input,
wherein the output control circuit comprises an AND gate with a first input terminal to which an output signal of the processor is input and a second input terminal to which an output signal of the flip-flop is input.

10. The display device according to the claim 7,
wherein carrier density of the oxide semiconductor film is less than 1×10¹²/cm³.

11. The display device according to the claim 7,
wherein hydrogen concentration of the oxide semiconductor film is less than 1×10¹⁶/cm³.

12. The display device according to the claim 7, wherein the display device is a liquid crystal display device.
